(19) United States
(12) Patent Application Publication
(10) Pub. No.: US 2025/0378019 A1
(43) Pub. Date: Dec. 11, 2025

(54) SYSTEMS AND METHODS FOR SCALING ARTIFICIAL INTELLIGENCE MEMORIES

(71) Applicant: BLUMIRA INC., Ann Arbor, MI (US)

(72) Inventor: Matthew Warner, Ann Arbor, MI (US)

(21) Appl. No.: 19/291,271

(22) Filed: Aug. 5, 2025

Related U.S. Application Data
(60) Provisional application No. 63/656,785, filed on Jun. 6, 2024.

(51) Int. Cl. G06F 12/02

(52) U.S. Cl. CPC G06F 12/023; G06F 2212/1044

(57) ABSTRACT

The present disclosure pertains to systems and methods for scaling artificial intelligence (AI) memories, addressing storage and relevancy in generative AI frameworks. The described aspects involve an approach for memory management where event summaries and contextual metadata are stored and memories are compressed to conserve storage space while retaining significant information. Various other methods and systems are also disclosed.

### PRIORITY CLAIMS TO RELATED APPLICATIONS

This application claims priority to U.S. Provisional Patent Application No. 63/656,785 filed Jun. 6, 2024, which is incorporated herein in its entirety by this reference.

### SUMMARY

In some aspects, the techniques described herein relate to a computer-implemented method including: storing, within a storage subsystem of a generative artificial intelligence system, memory of an event, wherein the memory of the event includes a summary of the event and context associated with the event; determining that the memory has exhibited reduced semantic relevance based on similarity scoring and access patterns for use in responding to prompts provided to the generative artificial intelligence system; in response to the determination that the memory has decreased in importance, compressing the memory such that the applying dimensionality reduction while preserving semantic relationships uses less storage space in the storage subsystem than an uncompressed memory of the event; replacing the uncompressed memory with the compressed memory in the storage subsystem; and using the compressed memory to respond to a prompt provided to the generative artificial intelligence system.

In some aspects, the techniques described herein relate to a system including: one or more physical processors; physical memory including computer-executable instructions that, when executed by the one or more physical processors, cause the one or more physical processors to: store, within a storage subsystem of a generative artificial intelligence system, memory of an event, wherein the memory of the event includes a summary of the event and context associated with the event, and determine that the memory has decreased in importance for use in responding to prompts provided to a generative artificial intelligence system, in response to the determination that the memory has decreased in importance, compress the memory such that the compressed memory uses less storage space in the storage subsystem than an uncompressed memory of the event, and replace the uncompressed memory with the compressed memory in the storage subsystem; and use the compressed memory to respond to a prompt provided to the generative artificial intelligence system.

In some aspects, the techniques described herein relate to a non-transitory computer-readable medium including computer-executable instructions that, when executed by one or more physical processors of a computing device, cause the computing device to: store, within a storage subsystem of a generative artificial intelligence system, memory of an event, wherein the memory of the event includes a summary of the event and context associated with the event, and determine that the memory has decreased in importance for use in responding to prompts provided to a generative artificial intelligence system, in response to the determination that the memory has decreased in importance, compress the memory such that the compressed memory uses less storage space in the storage subsystem than an uncompressed memory of the event, and replace the uncompressed memory with the compressed memory in the storage subsystem; and use the compressed memory to respond to a prompt provided to the generative artificial intelligence system.

### BRIEF DESCRIPTION OF DRAWINGS

The accompanying drawings illustrate a number of exemplary embodiments and are a part of the specification. Together with the following description, these drawings demonstrate and explain various principles of the present disclosure.

FIG. 1 shows a method for scaling artificial intelligence memories according to embodiments of the present disclosure.

FIG. 2 shows a block diagram of an exemplary process for scaling artificial intelligence according to embodiments of the present disclosure.

FIG. 3 shows a block diagram of an exemplary system for implementing embodiments described herein.

FIG. 4 shows an exemplary network environment in which embodiments of this disclosure can be implemented.

Throughout the drawings, identical reference characters and descriptions indicate similar, but not necessarily identical, elements. While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION OF EXEMPLARY EMBODIMENTS

While generative artificial intelligence (AI) has shown immense potential, its application has been limited due to domain expertise barriers, as a data input can only effectively be analyzed if supplied with supporting context to the relevancy and importance of the data. The generative AI framework discussed herein may address this and other shortcomings of traditional AI solutions by maintaining contextual metadata associated with memories and aging those memories based on their importance. In some examples, importance of memories may be determined by AI driven logic, by human tagging, or via both human and AI agents. The processes and/or systems for tagging memories may be referred to as memory tagging mechanisms (MTMs). Tagging memories by importance may enable more accurate and timely evaluation of new data while continuously reducing the need for storage of non-relevant or less relevant data.

As an overview, the generative AI framework disclosed herein may gain insights from existing memories and may review and compress memories based on their importance tags rather than by attempting to build an ever-growing contextual window. Information that is gathered via memory, or created via functions and stored in memories, then can be injected automatically into prompt context during future data and event analysis. This generative AI framework may include various attributes and components. For example, the generative AI framework may provide recall relevancy with memory compression, which provides the ability to age out and compress irrelevant or less relevant data over time. The generative AI framework may store events with lower relevancy as smaller quantized vectors and may repeatedly compress these vectors over time as data becomes more stale and/or less relevant, thereby creating a degradation of a “memory” effect. In other words, the generative AI framework may maintain contextual metadata associated with memories and may age those memories based on their importance (e.g., determined by a combination of human and AI driven logic of tagging memory criticality). This allows for more accurate and timely evaluation of new data while continuously reducing the need for storage for non-relevant data.

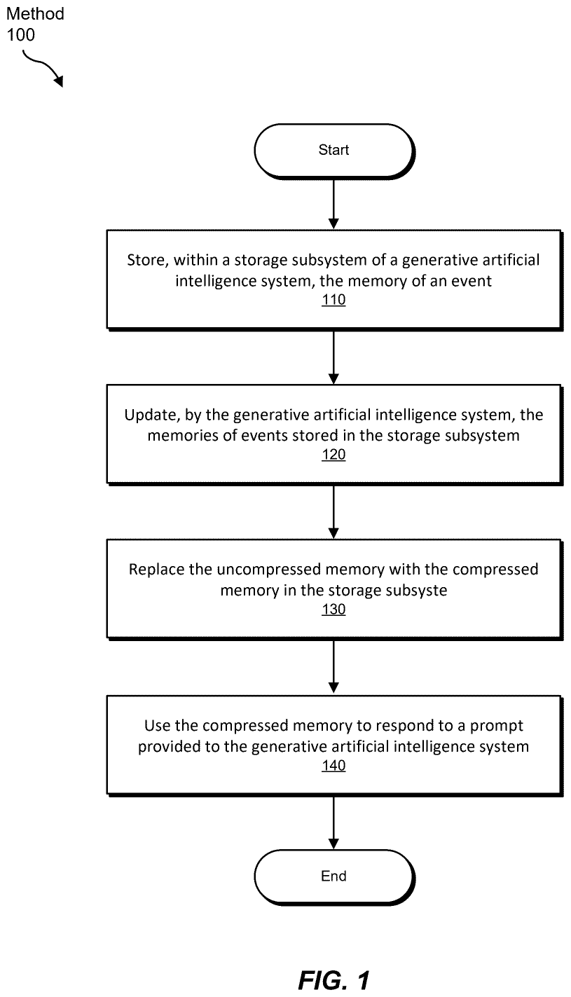

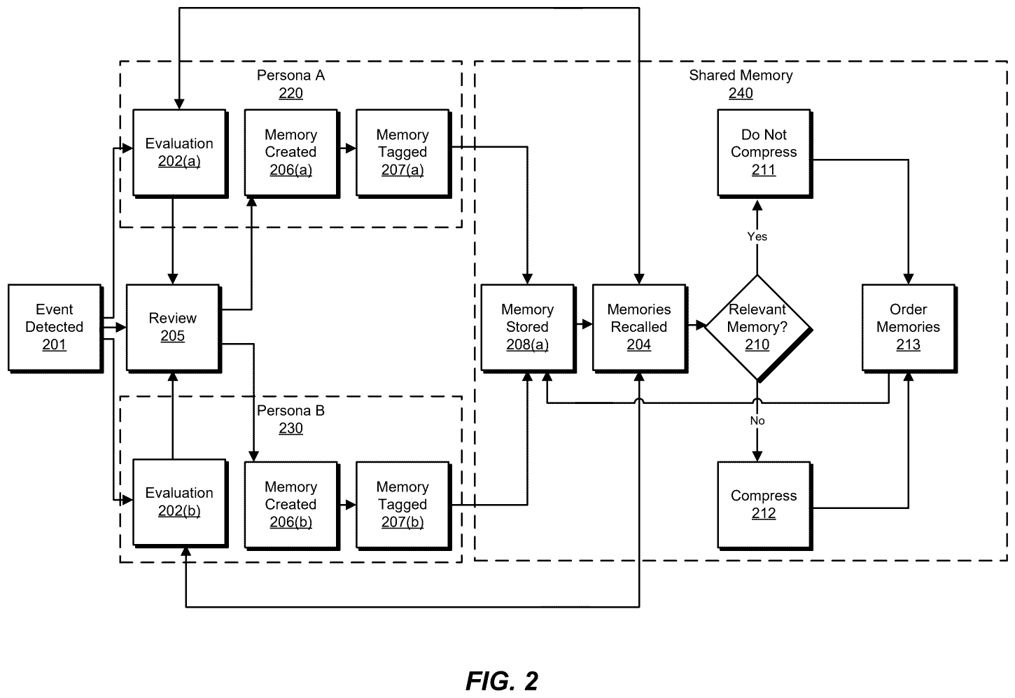

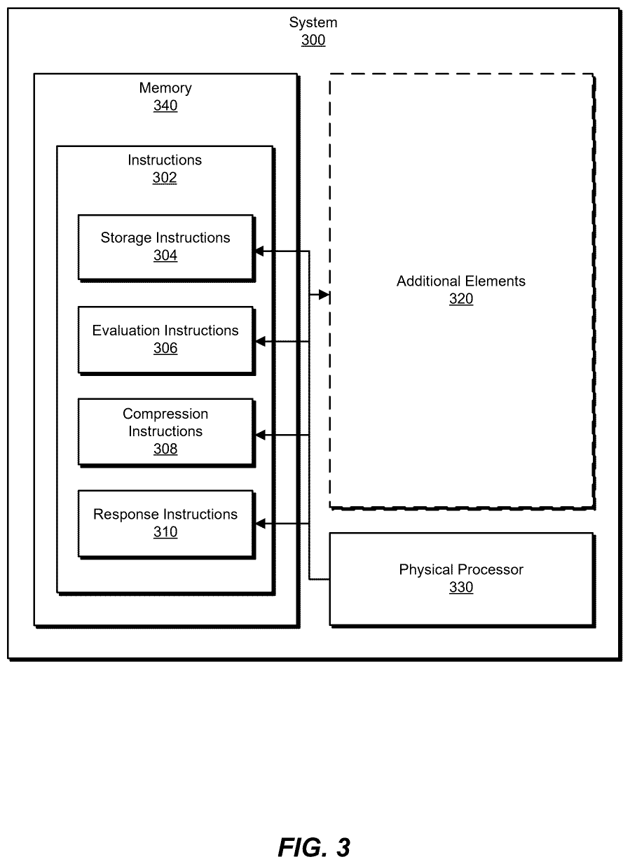

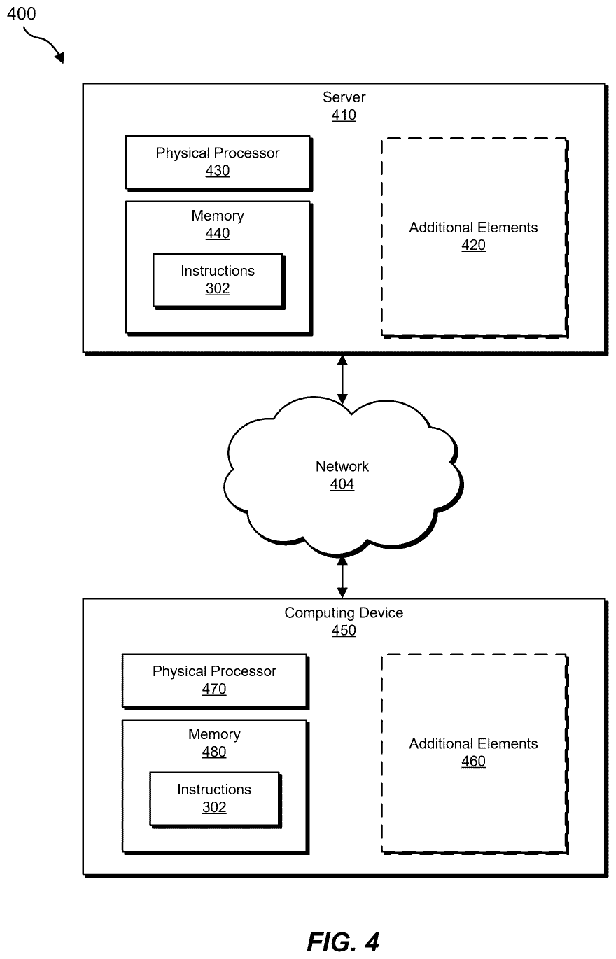

The following will provide, with reference to FIG. 1, an explanation of a method for scaling generative AI memories. The discussion corresponding to FIG. 2 presents an example workflow for scaling generative AI memories. The discussion corresponding to FIGS. 3 and 4 cover example computing systems and network environment in which embodiments of this disclosure may be implemented. The disclosure then turns to various exemplary use cases of the generative AI systems disclosed herein.

Turning to FIG. 1, a method 100 for scaling generative AI memories may include storing, within a storage subsystem of a generative AI system, the memory of an event (step 110). The memory of the event may include a summary of the event and context associated with the event, and the storage system may provide a finite amount of storage space.

The term “memory” generally refers to application of generative AI to store a summary of an event as well as contextual metadata associated with an event within a given domain. As discussed in greater detail below, memories may be aged and compressed over time depending on the level of importance for that domain. Memories may contain any type or form of data and may provide information about any type of event within any context, some examples of which are provided below. In other words, a memory can be a data structure or record generated and maintained by a generative artificial intelligence (AI) system, where the memory encapsulates a summary of an event and contextual metadata associated with that event within a particular domain.

A memory is not limited to a single data type or format; rather, it is a flexible construct that may include, but is not limited to, a summary of the event, contextual metadata, relevancy and importance tags, recall and access information, compression state, and links to related memories. The summary of the event may be a concise or detailed representation, such as natural language text, a structured data object, or a vector embedding (for example, a 2048-dimensional vector), designed to capture the essential elements of the event while omitting extraneous details. Contextual metadata provides additional information about the event, such as the time and date of occurrence, location, actors involved (e.g., human user, virtual agent, or system component), environmental conditions, and any other circumstances or parameters relevant to the interpretation of the event.

Memories may also include relevancy and importance tags, such as “core” or “non-core,” a relevancy score, or a criticality level, which may be assigned or updated by human users, AI agents, or both, as the importance of the memory changes over time. Recall and access information, such as how frequently the memory has been accessed, the time since last recall, and the number of times the memory has been referenced, may also be included. The compression state of a memory indicates whether it is stored in its original, uncompressed form or has been compressed (for example, by reducing the dimensionality of its vector representation) to conserve storage space. Additionally, memories may include linkages or references to other memories that are contextually or temporally related, enabling the AI system to reconstruct sequences of events or build richer context windows.

For example, in the context of a security information and event management (SIEM) system integrated with an extended detection and response (XDR) platform, a memory may represent a security incident such as a coordinated ransomware attack detected across multiple endpoints. In this example, a summary may state, “Coordinated ransomware activity detected on endpoints A, B, and C with lateral movement observed,” while the contextual metadata may include details such as the affected endpoints, user accounts involved, attack vectors, timestamps, detection rules triggered, and correlation identifiers linking related events. The memory may be tagged as “core” due to its criticality, stored as an uncompressed 2048-dimensional vector, and linked to other memories representing precursor or follow-up events, such as initial phishing attempts or subsequent remediation actions.

Other examples of memories include a user interaction memory, such as a user updating an account password, with metadata indicating the actor, event type, and timestamp, tagged as “non-core” and compressed to a 128-dimensional vector. In a manufacturing IoT context, a memory may record a temperature sensor exceeding a threshold on an assembly line, with relevant sensor and location metadata, and stored as a core, uncompressed memory. Additional examples include system maintenance memories (e.g., routine database backup completions), customer support interactions (e.g., password reset requests), and collaborative agent memories (e.g., joint review of incident reports by multiple agents), each with their own relevant metadata, tags, and compression states.

A memory may further include audit trails, user annotations, links to external data sources, or any other information that enhances the AI system's ability to recall, interpret, and utilize the memory in future analyses or responses. Memories may be created, updated, compressed, or deleted over time based on their ongoing relevance and the storage policies of the generative AI system.

The term “generative AI” generally refers to a type of artificial intelligence that can generate content through any of a variety of different types of algorithms and/or machine learning models. Examples of such models include large language models, which may be deep learning models that are pre-trained on significant amounts of data. In other words, generative AI can refers to a class of artificial intelligence systems and models that are capable of autonomously producing new content, data, or outputs that resemble or extend beyond the data on which they were trained.

In some examples, generative AI systems leverage advanced machine learning architectures—such as large language models (LLMs), transformer-based models, and other deep learning techniques—to synthesize information, generate predictions, and create novel outputs in response to prompts or evolving environmental stimuli. These models can be pre-trained on extensive datasets, enabling them to learn complex patterns and relationships within the data, and are subsequently fine-tuned or adapted for specific domains such as security operations, manufacturing, or mental health support.

As discussed in greater detail herein, generative AI can be utilized to generate and manage memories. For example, in a SIEM platform, generative AI can autonomously analyze security incidents, generate detailed summaries, assign relevancy tags, and update contextual metadata, thereby enabling more effective recall, evaluation, and response to future events. Generative AI models in this context may operate in autoregressive or conditional generation modes, producing outputs that are contextually relevant and tailored to the needs of the system, such as generating incident reports, recommending remediation actions, or synthesizing high-level summaries for human analysts.

Unlike traditional discriminative AI models, which may be primarily focused on classification or prediction, generative AI systems can be distinguished by their ability to synthesize new data, adapt to changing circumstances, and expand the boundaries of automated reasoning and decision support. These systems can be capable of reasoning, problem-solving, and adapting their outputs based on feedback, evolving context, or user interaction, making them particularly well-suited for applications that require continual learning, context-aware analysis, and dynamic content generation. As such, generative AI can form the foundation of the scalable, context-rich memory management and event analysis framework described in this disclosure.

The term “event” generally refers to any occurrence, happening, or trigger. Events may be occurrences within a digital domain (e.g., such as a security event, a data event, etc.) events within a physical domain (e.g., a power outage, a user's activity, etc.), or hybrid events (e.g., a user's interaction with a computer system). In some examples, an event can be any occurrence, happening, or trigger that is recognized, recorded, or processed by a generative artificial intelligence system. An event may originate from a wide variety of sources and may encompass activities, changes in state, or conditions within digital, physical, or hybrid environments. Events serve as the foundational units of information upon which memories are constructed and managed within the generative AI framework.

Within a digital domain, events may include security incidents such as unauthorized login attempts, malware detections, or data exfiltration alerts; system operations such as software updates, database backups, or application crashes; and user interactions such as password changes, file uploads, or access requests. In a physical domain, events may include occurrences such as a power outage, temperature fluctuations detected by IoT sensors, equipment malfunctions on a manufacturing line, or the presence of a person in a restricted area. Hybrid events may involve both digital and physical components, such as a user accessing a secure facility using a digital badge, or a remote command issued to a physical device via a networked application.

Examples of events include a coordinated ransomware attack detected across multiple endpoints in a security information and event management (SIEM) system, a user updating their account password in an enterprise application, a temperature sensor on an assembly line exceeding a predefined threshold in a manufacturing environment, a customer submitting a support request for password reset assistance via an online portal, a routine database backup operation completing successfully on a server, an AI agent and a human analyst jointly reviewing and annotating an incident report, or a system detecting an unusual login pattern from a new geographic location. Each event may be characterized by associated metadata, such as the time and date of occurrence, the actors or systems involved, the location, the type of event, and any other relevant contextual information. This detailed characterization enables the generative AI system to accurately summarize, tag, and manage events as memories, supporting advanced analysis, recall, and decision-making across a variety of domains.

The term “summary” generally refers to any explanation of an event and/or memory, details of an event or memory, or other information about an event or memory. In some embodiments, the summary may be a concise and compact overview of an event, may highlight essential elements of an event, and/or may not include unnecessary or unhelpful details about an event. In some embodiments, the summary may be stored as a vector of any suitable dimension. In one example, storing the summary as a 2048-dimension vector may provide a useful balance of increased accuracy and size. In other words, a summary can be a representation, explanation, or encapsulation of the essential details of an event or memory within a generative artificial intelligence system. A summary can be designed to provide a concise and compact overview that highlights the most relevant and significant elements of the underlying event or memory, while omitting extraneous, redundant, or unhelpful details. The purpose of the summary is to enable efficient recall, analysis, and contextualization of events or memories by both AI agents and human users. A summary may take various forms depending on the implementation and use case. It may be expressed as natural language text, such as a sentence or paragraph describing the event; as a structured data object containing key-value pairs that capture the main attributes of the event; or as a vector embedding of any suitable dimension, such as a 2048-dimensional vector, which encodes the semantic content of the event in a format optimized for storage, retrieval, and computational processing. The dimensionality of the vector may be selected based on the desired balance between accuracy, expressiveness, and storage efficiency, with higher-dimensional vectors generally capturing more nuanced information.

Examples of summaries include: “Coordinated ransomware activity detected on endpoints A, B, and C with lateral movement observed” for a security incident; “User John Doe updated account password” for a user interaction; “Temperature sensor T-300 on assembly line 3 exceeded threshold of 90° C.” for a manufacturing IoT event; “Routine database backup completed successfully on DB-Server-2” for a system maintenance operation; “Customer Jane Smith requested password reset assistance via email” for a customer support interaction; and “Agent A and Agent B jointly reviewed incident report #789 and recommended escalation” for a collaborative agent review. In each case, the summary distills the core information necessary to understand the nature, context, and significance of the event or memory, facilitating rapid access and effective use by the generative AI system. Summaries may be generated automatically by AI models, manually by human users, or through a combination of both, and may be updated over time as additional context or information becomes available.

The term “context” generally refers to any information about an event and/or a memory, including any circumstances, conditions, and/or surroundings that form the setting or environment in which an event occurs, is understood, or is interpreted. Context may encompass one or more factors that influence the meaning, relevance, and impact of an event and/or a memory. Context may include environmental factors (e.g., location, time, etc.), situational factors (e.g., circumstances, co-occurring events, etc.), and/or any other factor. In other words, context can refer to any information about an event or memory that describes the circumstances, conditions, or surroundings in which the event occurs, is understood, or is interpreted. Context can encompass a wide range of factors that influence the meaning, relevance, and impact of an event or memory within a generative artificial intelligence system. This may include environmental factors such as location, time, and date; situational factors such as co-occurring events, system states, or operational conditions; and any other parameters or metadata that provide additional insight into the setting or environment of the event. Context may also include information about the actors involved (such as human users, virtual agents, or system components), the relationships between different events or memories, and the broader domain or application in which the event takes place.

For example, in a security incident, context may include the affected endpoints, user accounts involved, attack vectors, detection rules triggered, and correlation identifiers linking related events. In a manufacturing IoT scenario, context could comprise sensor identifiers, equipment status, production line location, and recent maintenance activities. By capturing and leveraging context, the generative AI system can more accurately interpret, summarize, and respond to events, ensuring that analyses and actions are tailored to the specific circumstances in which each event or memory arises.

The term “metadata” may generally refer to data that provides descriptive, structural, or administrative information about other data, specifically about events or memories within a generative artificial intelligence system. Metadata serves to enrich the primary data by supplying additional details (e.g., context) that facilitate organization, identification, retrieval, and interpretation. Metadata may include attributes such as timestamps, locations, actor identities (e.g., user, agent, or system component), event types, relevancy or importance tags, recall frequency, compression state, and links to related events or memories. Metadata can also encompass audit trails, user annotations, and references to external data sources. By associating metadata with each event or memory, a generative AI system may be able to efficiently manage, search, and contextualize information, thereby enhancing its ability to perform accurate analysis, recall relevant information, and support decision-making processes across a variety of domains.

Metadata in context of a memory may be leveraged to identify the type of memory being stored and evaluated for better targeting and context building. This includes the ability to ascertain the type of actor (e.g., human vs virtual agent), as well as ensuring that memory-based summary and vector stores are easy to access to increase response rate and reduce hallucinations.

Metadata for the memory may also include an indication of relevancy of the memory. In some examples, this relevancy tagging may initially be performed by a human user or an AI agent and may be updated by a human user or AI agent through automated regular review. In some examples, initial tagging is performed by a human user and updates are performed by an AI agent.

Various types of relevancy information may be associated with a memory. For example, memories may be tagged as core or non-core. Core memories may hold higher value and may be aged more slowly than non-core memories. Core memories have higher relevance and may not degrade to allow recall at higher fidelity. Thus, core memories may be considered more important than non-core memories. Any other suitable designations in addition to, or instead of “core” and “non-core”, may be used to differentiate the importance or significance of memories.

At step 120 in FIG. 1 a generative AI system may update the memories of events stored in the storage subsystem. The generative AI framework may update a memory by determining that the memory has decreased in importance for use in responding to prompts provided to the generative AI system, and in response to the determination that the memory has decreased in importance, compress the memory such that the compressed memory uses less of the storage space in the storage subsystem than an uncompressed memory of the event.

Determining that a memory has decreased in importance may be performed in any suitable manner. For example, an AI agent may review the memory to determine whether it has been accessed recently, how old it is, what type of relevance tag it includes, etc. This memory evaluation may be context-derived (e.g., based on recent findings, login reports, etc.) and may be configurable for use in various different environments.

In some embodiments, the memory may be a shared memory, which is a memory and supporting metadata stored as a common memory (e.g., brain) with availability to two or more AI agents. Each agent may perform independent analysis, and these agents may have the ability to recall prior events with shared common understanding. In some embodiments, the agents may be multi-agent user personas, which may each have their own contextual memory, further enhancing evaluation by allowing for different personas to review and validate findings based on their own memories.

Upon determining a memory's importance, the generative AI framework may compress the memory in accordance with the importance, with less important memories being more significantly compressed than more important memories. In some embodiments, summaries of the memories may be stored as vectors within a vector database. Memories may also be stored as any other suitable data structure or format. Similarly, memories may be compressed using any of a variety of compression techniques or algorithms. For example, a memory stored as a vector may be quantized to a few dimensions or to as many as thousands of dimensions. In some examples, the memory vector may be compressed to 2 dimensions. In some examples, the memory vector may be compressed to 16,384 dimensions. In some examples, the memory vector may be compressed to 8,192 dimensions. In some examples, the memory vector may be compressed to 4,096 dimensions. In some examples, the memory vector may be compressed to 1024 dimensions. In some examples, the memory vector may be compressed to 512 vectors. In some examples, the memory vector may be compressed to 256 dimensions. In some examples, the memory vector may be compressed to 128 dimensions. In some examples, the memory vector may be compressed to 64 dimensions. In some examples, the memory vector may be compressed to 32 dimensions. In some examples, the memory vector may be compressed to 32 dimensions. In some examples, the memory vector may be compressed to 16 dimensions. In some examples, the memory vector may be compressed to 8 dimensions. In some examples, the memory vector may be compressed to 4 dimensions. In some examples, the memory vector may be compressed to 2 dimensions.

The focus during the process of quantization or compressing memory vectors to lower dimensions is to still preserve a general understanding of the original source data. By reducing the dimensionality of the vectors, the system can efficiently store and process the information without losing the essential characteristics of the data.

At step 130 in FIG. 1, the generative AI framework may replace the uncompressed memory with the compressed memory in the storage subsystem. As a result, the memory may take up less space in the storage system, which may enable the generative AI system to maintain a set of continually-updated memories.

In some embodiments, evaluation and compression of memories may be performed periodically. In some examples, evaluation and compression may be performed every minute. In some examples, evaluation and compression may be performed every hour. In some examples, evaluation and compression may be performed every day. Evaluation and compression may also be performed at any other suitable interval. Alternatively, evaluation and compression may be triggered by a particular event, manually by a human user, or in any other suitable manner.

Memories can be stored in such a way that the originating memory is referred to and updated during the compression events. This maintains the original context of the memory, enables fast navigation and searching of the memory, as well the ability to extend memories across different use cases.

At step 140 in FIG. 1, the generative AI system may use the compressed memory to respond to a prompt, as explained in greater detail in the example provided in FIG. 2. In some examples, this step involves retrieving one or more memories that have previously been compressed—meaning their summaries and associated metadata have been stored in a more storage-efficient format, such as a lower-dimensional vector or a condensed textual summary—and injecting the relevant information from these memories into the context window of the generative AI model when a new prompt or query is received.

The process may begin when the generative AI system receives a prompt, which may be a user query, an automated system request, or an internal trigger for analysis or action. The system may then searches it memory store, including both compressed and uncompressed memories, to identify those that are most relevant to the prompt. Relevance may be determined based on metadata such as event type, actors involved, time of occurrence, or semantic similarity between the prompt and stored memory vectors. Once the relevant compressed memories are identified, their summaries and contextual metadata are extracted and incorporated into the input context for the generative AI model.

For example, in a security operations use case, if a prompt requests an analysis of recent suspicious activity on a particular endpoint, the system may retrieve compressed memories related to previous security incidents involving that endpoint. These could include compressed summaries such as “Unauthorized login attempt detected on endpoint X,” along with metadata indicating the time, user account, and detection method. The generative AI model then uses this information to provide a comprehensive response, such as correlating the current activity with past incidents, identifying patterns, or recommending specific remediation steps. In a manufacturing IoT scenario, a prompt might request a report on equipment anomalies over the past month. The system would retrieve compressed memories summarizing events like “Temperature sensor T-300 exceeded threshold on assembly line 3,” “Unexpected shutdown of conveyor belt B,” or “Routine maintenance completed on robotic arm A.” The generative AI model can then synthesize these compressed memories to generate a summary report, highlight recurring issues, or suggest preventive maintenance actions.

Other examples include customer support, where a prompt about a customer's recent interactions may trigger retrieval of compressed memories like “Customer Jane Smith requested password reset assistance via email” and “Customer reported billing issue resolved on 2024 May 10.” In collaborative agent environments, a prompt to review the status of an incident may result in the system recalling compressed memories such as “Agent A and Agent B jointly reviewed incident report #789 and recommended escalation.”

By leveraging compressed memories in this manner, the generative AI system is able to efficiently utilize historical information, maintain high response performance, and provide contextually rich and accurate answers, even as the volume of stored memories grows over time. This approach ensures that only the most relevant and essential information is surfaced in response to each prompt, while minimizing storage and computational overhead.

In some embodiments, the described method also involves storing, within the storage subsystem of a generative artificial intelligence system, a memory corresponding to an additional event. This additional memory can include context that designates it as a core memory, signifying that it holds higher importance within the system. In contrast, the memory of the original event may be identified as a non-core memory, indicating it is of lesser significance. As a result, the core memory associated with the additional event may be prioritized over the non-core memory. For example, in a security operations context, a memory representing a major ransomware attack affecting multiple endpoints may be tagged as a core memory and stored in an uncompressed, high-dimensional vector format to preserve detail and ensure rapid recall. Meanwhile, a memory representing a routine password change by a user may be tagged as non-core and stored in a compressed, lower-dimensional format to conserve storage. This approach enables the system to prioritize and retain critical information at higher fidelity, while less important data is compressed to increase storage efficiency.

In certain implementations, the method involves handling events specifically related to security incidents. When such a security event occurs, the process of storing the memory of this event can include an evaluation conducted by multiple artificial intelligence agents within a security operations center. These AI agents can work collaboratively to analyze the event, identify its context, and generate a comprehensive summary. For instance, consider a scenario where an unauthorized access attempt is detected on a corporate network. The AI agents can assess various aspects of the incident, such as the time of the attempt, the IP address involved, and any triggered security protocols. The agents can then compile this information into a detailed summary that captures the essential elements of the event. This summary, along with the contextual metadata, is stored as a memory within the AI system, enabling future recall and analysis. This approach ensures that security events are thoroughly documented and contextualized, facilitating more effective monitoring and response strategies.

In some embodiments, the process of compressing a memory involves quantizing a vector that represents the summary of the event. This means that the system takes the original, often high-dimensional vector embedding—which encodes the essential details and context of the event—and applies a quantization technique to reduce its size and complexity. For example, if a memory summary is initially stored as a 2048-dimensional vector, quantization may reduce it to a lower-dimensional representation, such as 128 or 64 dimensions, while preserving the most important semantic information. This approach enables the generative AI system to store more memories efficiently, as each compressed memory occupies less space, yet still retains enough detail to be useful for future recall and analysis. For instance, a memory summarizing a routine system backup can be quantized to a small vector, while a memory of a critical security breach may remain in a higher-dimensional, less-compressed form. Quantization thus enables dynamic and scalable memory management within the AI framework.

Some examples involve determining whether a memory has decreased in importance. In such examples, determining whether a memory has decreased in importance can involve evaluating several factors related to how the memory is used and its current relevance within the system. For example, the generative AI system may assess the amount of time that has passed since the memory was last accessed; if a particular memory has not been referenced or used in a significant period, it may be considered less important. Similarly, the system may consider the age of the memory by looking at the time since it was originally created—older memories that have not been recently accessed may be candidates for compression. Additionally, the system can review relevancy tags that are associated with each memory. These tags, which may be assigned by human users or AI agents, indicate the current significance or criticality of the memory, such as “core” for highly important memories or “non-core” for less significant ones. For instance, a memory tagged as “non-core” and not accessed in several months may be automatically selected for compression, while a recently accessed “core” memory may remain uncompressed to ensure rapid recall. This evaluation process enables the AI system to dynamically manage storage resources by prioritizing the retention of the most relevant and frequently used information.

In some scenarios, the memory is implemented as a shared resource that can be accessed by multiple artificial intelligence agents within the system. Each of these agents also maintains its own independent contextual memory, allowing for both collaborative and individualized analysis. For example, in a security operations environment, several AI agents may work together to monitor and respond to threats. They can all access a common pool of shared memories—such as records of past security incidents or system anomalies—while also relying on their own unique contextual memories that reflect their specific roles, expertise, or recent activities. This structure enables agents to contribute to a collective understanding of events, validate findings from different perspectives, and enhance the overall accuracy and effectiveness of the system's responses. For instance, one agent can specialize in detecting network intrusions, while another focuses on user behavior analytics; both can draw from the shared memory to inform their decisions, but each also leverages its own contextual insights to provide a more nuanced evaluation.

When a generative AI system uses compressed memory to respond to a prompt, this process can involve injecting the relevant compressed memory into the context window of a generative artificial intelligence model. In practice, this means that when a user or system issues a query—such as requesting a summary of recent security incidents or asking for a report on equipment anomalies—the system identifies and retrieves the most pertinent compressed memories. These compressed memories, which may be stored as lower-dimensional vectors or concise summaries, are then incorporated into the input context provided to the generative AI model. For example, if an analyst asks for information about suspicious activity on a specific endpoint, the system can inject compressed memories related to previous incidents involving that endpoint into the model's context window. This enables the AI model to generate a response that is informed by relevant historical data, even when storage constraints require that much of this data be stored in a compressed form.

In certain embodiments, the process of compressing a memory involves applying a dynamic compression factor that is determined based on factors such as available storage space, the relevancy of the memory, or a predefined minimum level of compression (referred to as a compression floor). For example, if the storage subsystem is nearing capacity, the system may increase the compression rate for less important memories, reducing their dimensionality more aggressively to free up space. Conversely, highly relevant or “core” memories may be compressed less or not at all, preserving their detail for rapid recall. The system may also enforce a compression floor, ensuring that even the most aggressively compressed memories retain a minimum number of dimensions—such as 128 or 32—to maintain a baseline level of information. For instance, a memory about a routine system backup might be compressed to the minimum allowed size, while a memory about a critical security breach would be stored with much higher fidelity.

In addition to available storage space, relevancy of the memory, and a predefined compression floor, the dynamic compression factor can be determined based on a variety of other factors. For example, the frequency with which a memory is accessed or recalled can influence compression—memories that are rarely accessed may be compressed more aggressively, while those frequently referenced may retain higher fidelity. The age of the memory is another consideration; older memories that have not been recently used may be candidates for greater compression. The type or category of the event associated with the memory can also play a role, with critical security incidents or regulatory compliance events being compressed less than routine operational logs.

Other factors include the sensitivity or confidentiality of the information contained within the memory, where highly sensitive data may be preserved at higher resolution for audit or forensic purposes. The anticipated future utility of the memory, as predicted by AI models or user input, can also affect compression decisions—memories expected to be relevant for upcoming analyses or investigations may be compressed less. System performance metrics, such as current processing load or bandwidth availability, may further influence the compression factor, with higher compression applied during peak usage periods to optimize resource allocation.

Additionally, organizational policies or user-defined rules can dictate compression strategies, such as retaining certain types of memories in uncompressed form for a minimum retention period. The presence of linked or related memories may also be considered; for example, if a memory is part of a sequence of events that are frequently analyzed together, the system may choose to compress it less to preserve contextual integrity. By taking into account these and other factors, the generative AI system can dynamically and intelligently manage memory compression to optimize both storage efficiency and information utility.

When the system replaces an uncompressed memory with its compressed version, it ensures that a reference to the original context of the memory is maintained. This approach allows for efficient navigation and searching of the memory, even after compression. For example, consider a scenario where a detailed memory of a security breach is compressed to save storage space. Although the memory is now stored in a more compact form, the system retains a reference to its original context, such as the specific details of the breach, the affected systems, and the timeline of events. This reference acts as a pointer, enabling the system to quickly locate and retrieve the full context if needed for deeper analysis or investigation.

The process shown in FIG. 2 provides an overview of a security use case for embodiments of this disclosure that may reduce the dependence on human-staffed Security Operations Centers (SOCs). In FIG. 2, element 220, labeled as Persona A, refers to an individual AI agent that participates in the evaluation and creation of memories. Persona A independently evaluates detected events, creates corresponding memories, and tags those memories with relevancy or importance before contributing them to the shared memory pool. For example, Persona A can be an AI agent specializing in network security analysis, reviewing events for potential threats and generating detailed summaries and metadata for each incident. Element 230, labeled as Persona B, functions similarly to Persona A but represents a different AI agent, potentially with a distinct area of expertise or analytical approach. Persona B also evaluates events, creates memories, and applies relevancy tags. For instance, Persona B may focus on user behavior analytics, identifying unusual login patterns or access anomalies and generating its own set of memories and contextual information.

Element 240, labeled as Shared Memory, is a centralized repository accessible by multiple personas or agents. Shared Memory aggregates the memories created and tagged by different personas, enabling collaborative analysis and collective intelligence. This shared resource allows all participating agents to recall, update, and reference memories, supporting coordinated decision-making and reducing the risk of information silos. For example, both Persona A and Persona B can access Shared Memory to review past incidents, correlate findings, and enhance the accuracy and depth of their analyses. This structure supports a multi-agent, context-rich environment where diverse perspectives contribute to a more robust and scalable AI memory management system.

As shown in FIG. 2, at step 201 a security system may detf4ect a security event in a customer environment. The security system may detect the security event in any suitable manner. For example, the security system may use a detection rules engine that has been customized for a particular customer's environment to detect the security event. Alternatively, the security system may use a general detection rules engine to detect the security event.

The generative AI system may perform continuous monitoring for any type or form of security event, including security breaches (e.g., unauthorized access to a network or system, etc.), vulnerabilities (e.g., weak data encryption, weak authentication credentials, unpatched software, etc.), suspicious activity (e.g., phishing attempts, social engineering attacks, unusual login patterns or locations, etc.), compliance violations (e.g., violations of an organization's security policies or compliance requirements), system failures (e.g., failure or malfunction in hardware or software systems), and/or threat intelligence (e.g., insights about emerging threats).

At steps 202(a) and 202(b) in FIG. 2, a security system may detect an event evaluated by one or more AI ‘SOC’ agents. Each evaluation may be stored in memory with metadata context for follow-on agent evaluation extraction and context population to reduce hallucination.

At steps 203(a) and 203(b) in FIG. 2, to provide context for the event, the security system may access a shared memory, which provides historical context to other events and security incidents that have previously occurred in the organization's environment.

If a memory is recalled, at step 204 in FIG. 2, the security system may update metadata around that memory to reflect this (timestamp since last recall, recall frequency etc.).

At step 205 in FIG. 2, the AI security agents may review together and come to an internal consensus regarding the significance of the event and may provide proposed next steps via coordinated memory evaluation. These may initially be sent to the organization for review but may ultimately be acted upon autonomously by the AI agent.

At steps 206(a) and 206(b) in FIG. 2, each agent may generate a semantic summary and memory vector of evaluation (N dimensions, such as 2048). The semantic summary may be any human- and/or computer-readable summary description of the event. The memory vector may include various types of data about the event. For example, the memory vector may include corresponding metadata properties referenced in step 4.

At steps 207(a) and 207(b) in FIG. 2, the security system may tag the memory with relevancy. This may initially be performed by a human user but may ultimately be tagged by an AI agent through automated regular review. Example relevancy types include core and non-core. Core memories hold higher value and are aged more slowly than non-core memories (see step 9+ below).

At step 208 in FIG. 2, the memory vectors from each agent may be stored with a unique set of metadata, which could be a specific organization's environment.

At step 209 in FIG. 2, Every N hours, a memory evaluation batch job may run across all memories in shared memory. The process of memory evaluation may include substeps 10-13.

At step 210 in FIG. 2, the security system may evaluate the memories for relevancy (this may include user tagging, see step 7, or time since last recalled, time since creation etc.)

As step 211 in FIG. 2, if a memory is determined to be relevant, memory compression may be skipped.

As step 212 in FIG. 2, if a memory is determined to be less relevant or irrelevant, the memory may be compressed by a factor of N. The compression factor may be dynamic depending on storage limits and relevancy of memory. Thus, more irrelevant memories may be aged faster. In some embodiments a compression floor may be built in (e.g., of 128 dimensions, 32 dimensions, etc.).

At step 213 in FIG. 2, the memory structure may be re-optimized and re-ordered based on relevancy and recall metadata to allow for more streamlined future memory recall.

FIG. 3 illustrates a system architecture 300 for implementing scalable artificial intelligence memories, as described in the detailed description. The system 300 includes memory 340, which stores instructions 302 that are executed by a physical processor 330 (i.e., computer-executable instructions). The instructions 302 are organized into functional modules, including storage instructions 304, evaluation instructions 306, compression instructions 308, and response instructions 310. The storage instructions 304 are responsible for storing memories of events, which may include summaries and contextual metadata, within the system's storage subsystem. Evaluation instructions 306 enable the system to assess the importance or relevancy of each memory, for example by analyzing metadata such as access frequency, age, or relevancy tags. Compression instructions 308 are used to reduce the storage footprint of less important memories, such as by quantizing or reducing the dimensionality of memory vectors, while ensuring that essential information is preserved for future recall. Response instructions 310 facilitate the retrieval and use of both compressed and uncompressed memories in response to prompts, injecting relevant information into the context window of the generative AI model.

The system 300 may also include additional elements 320, which can represent other hardware or software components necessary for operation, such as network interfaces, user interfaces, or external storage devices. For example, in a security operations use case, the storage instructions 304 may store a memory representing a detected ransomware attack, the evaluation instructions 306 may determine that this memory is highly relevant and should remain uncompressed, and the response instructions 310 may retrieve this memory when a prompt requests analysis of related security incidents. In a manufacturing IoT scenario, the compression instructions 308 may periodically compress older, less relevant sensor event memories to conserve storage, while still allowing the response instructions 310 to access and synthesize these compressed memories when generating reports on equipment anomalies. The physical processor 330 executes these instructions, transforming data and managing the lifecycle of memories within the generative AI framework. This architecture enables the system to efficiently scale, adapt to different domains, and maintain high performance as the volume of stored memories increases.

FIG. 4 depicts a system diagram 400 for implementing scalable artificial intelligence memories, illustrating the interaction between various components within a networked environment. The diagram shows a server 410 and a computing device 450. The server 410 includes a physical processor 430, memory 440, and instructions 302. The memory 440 stores these instructions, which are organized into modules responsible for tasks such as storing, evaluating, compressing, and responding to event memories. Additional elements 420 within the server may include network interfaces, user interfaces, or other hardware and software components necessary for the system's operation.

The computing device 450 mirrors the server's architecture, with its own physical processor 470, memory 480, instructions 302, and additional elements 460, enabling it to perform similar functions. The network 404 connects the server and the computing device, facilitating communication and data exchange between them. This setup enables distributed processing and storage, allowing the system to efficiently manage and scale the handling of AI memories across different devices and locations.

In practical applications, such as a security operations center, the server 410 may store and process critical security event data, while the computing device 450 can be used by analysts to access and interact with this data. For instance, the server may store a memory of a detected ransomware attack, while the computing device retrieves and analyzes this memory in response to a security alert. In a manufacturing IoT context, the server may compress and store sensor data, while the computing device generates reports on equipment performance. This architecture supports the generative AI system's ability to adapt to various domains, maintain high performance, and ensure that relevant information is readily accessible for decision-making and analysis.

In the context of a security information and event management (SIEM) platform, FIG. 4 illustrates how the system architecture supports scalable and efficient handling of security event data using artificial intelligence. In this example, the server 410 operates as the central processing hub for the SIEM platform, equipped with a physical processor 430, memory 440, and instructions 302 that execute core functions such as storing, evaluating, compressing, and responding to security event memories. The server continuously ingests and processes security events from across an organization's infrastructure, such as unauthorized login attempts, malware detections, or suspicious network activity. These events are stored as structured memories, each containing summaries, contextual metadata, and relevancy tags. When a new security alert or query is generated—such as an analyst requesting a report on recent ransomware activity—the computing device 450, which may be a workstation used by a security analyst, connects to the server 410 via the network 404.

The analyst's computing device 450, with its own processor 470 and memory 480, runs instructions 302 that allow it to securely access, retrieve, and interact with the relevant compressed or uncompressed memories stored on the server. For example, the analyst may query the system for all events related to a specific endpoint or user account. The server 410 identifies and transmits the most relevant compressed memories, such as “Coordinated ransomware activity detected on endpoints A, B, and C,” along with associated metadata like timestamps, affected systems, and detection methods.

The analyst can then review these memories, correlate them with other incidents, and determine appropriate response actions, such as isolating affected endpoints or escalating the incident for further investigation. The server may also update the recall metadata for each memory accessed, ensuring that the system maintains an accurate record of which events are most frequently referenced and should remain uncompressed for rapid access. This distributed architecture allows the SIEM platform to efficiently scale across large organizations, maintain high performance, and provide security teams with timely, context-rich insights for threat detection, investigation, and response.

As shown, the systems and methods described herein may leverage generative AI through a detection engine and structured evidence data to provide security. This context-rich foundation may enable generative AI to generate insights and virtual “eyes-on-glass” for security analysts by monitoring an organization's infrastructure and by detecting, analyzing, and responding to security incidents in real-time. Embodiments of this disclosure may enable an SOC team to maintain vigilance over an organization's networks, systems, and applications and may ensure a proactive defense posture against cyber threats. By leveraging generative AI, the systems and methods described here can further reduce response times and alert a customer support team to assist when a true breach is detected. This framework will not only improve analyst quality of life through clearer explanations, but also enhance correlation and risk identification across a customer's technology environment.

In some embodiments, the generative AI framework of this disclosure may provide 24×7 AI on Glass in a manner that is multi-minded, semantic, and structured. For example, a generative AI system may review every finding and may make the determination for each alert or datapoint brought to it. The generative AI system may, without being asked, enrich and investigate based on the inquiry. And if an inquiry identifies a new pattern, the generative AI system may determine whether it is a new finding or a contextual milestone.

The generative AI system disclosed herein may also run reports regularly and provide reviews and alerts. In some examples, the generative AI system may also, based upon review and investigation, determine in semantic and structured ways the needed responsive action for the finding or data being investigated. This may mean no action is required, or that there is a need to start isolating hosts immediately. Thus, the generative AI system may act as a stage-gate to perform response and notification.

In some embodiments, the generative AI system may execute a response. Alternatively, the generative AI framework may broker a response, as a traditional SOC would. In such embodiments, the generative AI framework may need to be aware as to what is required for response. As an example, the generative AI framework may identify the need to lock out user X on M365 on tenant ID Z to avoid further threats and the structure {“action”: “lock_out”, “target”: “X”, “type”: “M365”, “type_id”: “Z”} for an external service to then ingest.

The generative AI framework may also notify stakeholders via the ways the AI agents have identified as stakeholders' preferences to be notified. The generative AI framework may also learn from its actions and may provide clear conversation with flexible investigations.

In some examples, a system with large language models can reliably generate JSON data, generally evaluated at 0 temperature to ensure less randomness in the evaluation and response. By building context into agents via prompting, the only need from the model may be strong context window handling.

In some examples, implementation may involve the following steps:
1. Data Gather: Identify starting point of evaluation, e.g., Finding ID 1A
2. Generate: Determine Initial Response—Generate initial evaluation of the initially gathered data, outputting a JSON representation of the initial determination. Extract and evaluate data from the original evidence and analysis for future utilization such as, IP addresses, domains, usernames, priority, time to act, confidence, etc. Output may be controlled through JSON schema to verify that the output must look a certain way else it should be rerun.

This is a Finding (like a security alert/detection) from a security platform. You are a security analyst hedgehog that evaluates detections in a virtual SOC. This is very important; this is a detected Finding that breaches an organization's rules, or at least something the organization needs to address. You must evaluate the data and determine if this is a true detection; this is your main task. Identify if this is a non-threatening detection and should be tuned based on data provided or needs to be acted on or investigated more. Identify steps for investigation. Identify steps for remediation. Your steps should be clear and be able to be followed.

Your output should follow the specified format with the keys determination (true positive, false positive, noise, similar), your confidence (1-100), your threat scale (1 is likely normal business and likely not an active threat, 100 is a true active threat, if closer to 1 it does not need to be investigated immediately or could be a tunable alert whereas 100 should be investigated immediately), analysis (why and how it could have happened), and investigation (what to do next, what are the steps). You will take the existing tags and filters into consideration when determining the scores and analysis.
3. Data Gather: Gather all additional data based on the extracted information, e.g., all other Findings with this IP, other Findings with this name, and organizational information to load into future prompts. Memory storage is evaluated, metadata context is crawled for core memories as well as related investigations by vector or metadata context.
4. Generate: Determine Agent Evaluation Response: Moving onto the second stage of evaluation leveraging generated Chain of Thought prompting methods, e.g., “Think this through step-by-step” to elicit full readout of the original starting point and new information. This is done by providing all additional data associated with the initial evaluation and asking the large language model to consider the weighting of the new data being provided to the environment. Additionally, we ask the large language model at this point to determine how this could be a false positive and if this is that situation.

You are a middleware security analyst Agent that determines if the analysis and evaluation require attention based on hours to act. Your goal is to ensure that issues are properly triaged and that people are not paged/woken up inappropriately. You should output your determination of if immediate response is required, specifically, should a human be woken up for this.
5. Generate: Determine High-Level Sentiment—Based off of the agent evaluation, what is the high-level sentiment and actions to take? Part of the cohort Agent team being leveraged to ingest memories.

Generate a very high level and short writeup of the provided analysis the AI SOC analyst.

Provide a very short response with clear directions on
What happened
What's the impact
What should they do next
Remainder of previous context and memories
6. Generate: Determine Actions Sentiment—Based off of the agent evaluation, original finding, additional findings, and additional data, what actions should be taken next? This is to create a json-formatted list of actions to take within the environment associated with IoCs identified.

Based on the following output from an analyst, what actions ranging from isolation to investigation should be taken next.

You should always aim to reduce end-user downtime (due to lockouts or isolation) and maintain user happiness while still ensuring security needs are met. Keeping in mind this could be a false positive.

The actions should include references to specific users, hosts, and services where relevant. Placeholders should not be used.

```
List in order of priority in JSON format
  [
    {
      “action”: str,
      “target”: str,
      “priority”: int
    }
    ]
    ...(remainder of previous context and memories)
```

7. Return a json blob with all of the above generated and gathered information as the full evaluation is now complete.
7(a). Utilize the gathered and written information to create the first pass of the chat for this Finding ID utilizing the initial object, finding object, additional detections, high-level summary, and analyst evaluation.
7(a)(i) To be pre-written to contextual memory storage for chat.
7(b) Utilize actions generated to determine if any are available for automation, e.g., HOST_A should be isolated—is HOST_A an agent host? Some embodiments may use smaller models for this model extraction to reduce cost.
8. Memories associated with this are now defined across each stage of investigation within the contextual memory store.

In addition to security use cases, embodiments of this disclosure may be implemented for a variety of other use cases. For example, the generative AI framework discussed herein may be implemented in a manufacturing internet of things (IoT) use case as a multi-agent generative AI framework with shared memory in a manufacturing ecosystem. In this example, the generative AI framework may be configured to support generative AI agents in recalling and leveraging past memories and events to simulate complex network scenarios where multiple IoT devices communicate. The generative AI system may predict outcomes, propose optimizations, and train systems to handle unexpected disruptions or optimize energy use. For example, the generative AI system may perform predictive maintenance by utilizing historical performance data to predict and prevent equipment failures. As another example, the generative AI system may perform operational optimization by analyzing past efficiency metrics to adjust production processes for improved productivity. The generative AI system may also perform data integrity and security tasks such as ensuring that historical data is stored securely and used responsibly to maintain system reliability and trust.

Another exemplary use case is for mental health. In this example, a multi-agent generative AI system with shared memory may be configured to support a human user through emotional problems by providing an AI relationship. In this example, the generative AI system may be configured to support generative AI agents each with unique personality traits (e.g., supportive, adventurous, intellectual, etc.). Agents may interact with a user based on the user's mood or need for specific emotional support, providing more nuanced companionship than available via traditional AI systems. Personalized interactions provided by the AI system may include remembering user preferences through highly-referenced memories, past conversations, and important personal details (via memory tagging) to customize interactions to meet a user's current needs. The generative AI systems disclosed herein may also provide emotional engagement by using memory of emotional cues and past reactions to enhance relational depth. The generative AI system may be capable of adaptive learning, changing behavioral patterns over time to align more closely with user's evolving preferences and life changes based on memory relevancy and aging.

As shown, application of scalable evolving AI memory can extend to any suitable use of AI for long-term continual problem solving with user-driven, patterned-based behavior. Compressing less important data over time will drive lower storage and processing requirements, a key issue with scaling large language models.

The methods described here provide a technical solution to the technical problem of efficiently managing and scaling memory storage within generative artificial intelligence systems, particularly as the volume of stored data grows over time. In traditional AI and data storage systems, the accumulation of event data and contextual information can quickly overwhelm available storage resources, leading to degraded system performance, increased costs, and slower response times. Additionally, indiscriminate retention of all data, regardless of its ongoing relevance, can make it difficult for AI models to access and utilize the most pertinent information when generating responses to prompts.

The technical solution offered by this method involves a multi-step process that intelligently manages the lifecycle of memories within the AI system. First, the system stores a memory of each event, including both a summary and associated context, within a dedicated storage subsystem. The system then continuously or periodically evaluates the importance of each memory, using criteria such as access frequency, age, and relevancy tags. When a memory is determined to have decreased in importance, the system compresses it—typically by reducing the dimensionality of its vector representation or condensing its summary—so that it occupies less storage space. The uncompressed version is replaced with the compressed version, and the system maintains references to the original context to ensure that the memory remains navigable and searchable. Finally, when a prompt is received, the system is able to use the compressed memory to inform its response, injecting only the most relevant and storage-efficient information into the context window of the generative AI model.

This approach addresses the technical challenges of storage scalability, memory retrieval efficiency, and system responsiveness. By dynamically compressing less important memories and prioritizing the retention of high-value information, the system reduces storage overhead and computational burden, enabling the AI to operate effectively even as the dataset grows. For example, in a security operations context, critical incidents such as coordinated ransomware attacks are retained in high fidelity for rapid recall, while routine events like password changes are compressed to conserve resources. This ensures that the AI system can quickly access and synthesize relevant historical data, improving the quality and speed of its responses to user queries or automated triggers. The method's technical innovation lies in its ability to balance storage efficiency with information utility, providing a scalable and adaptive memory management framework that directly addresses the limitations of conventional AI memory systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the systems described herein may transform data, physical devices, and/or representations of physical devices from one form to another. Additionally or alternatively, one or more of the systems recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

What is claimed is:

1. A computer-implemented method comprising:
storing, within a storage subsystem of a generative artificial intelligence system, structured memory representation comprising vectorized and semantic event data, wherein the memory of the event comprises a summary of the event and context associated with the event;
determining that the memory has decreased in importance for use in responding to prompts provided to the generative artificial intelligence system;
in response to the determination that the memory has decreased in importance, compressing the memory such that the compressed memory uses less storage space in the storage subsystem than an uncompressed memory of the event;
replacing the uncompressed memory with the compressed memory in the storage subsystem; and
using the compressed memory to respond to a prompt provided to the generative artificial intelligence system.

2. The method of claim 1, further comprising:
storing, within a storage subsystem of a generative artificial intelligence system, a memory of an additional event, wherein:
the memory of the additional event comprises context indicating that the memory is a core memory; and
the memory of the event comprises a non-core memory; and
the memory of the additional event has greater importance than the memory of the event and takes up more storage space in the storage subsystem than the memory of the event.

3. The method of claim 1, wherein:
the event comprises a security event; and
storing the memory of the event comprises evaluating the event by a plurality of artificial intelligence security operations center agents to identify the context and create the summary.

4. The method of claim 1, wherein compressing the compressed memory comprises quantizing a vector that stores the summary of the event.

5. The method of claim 1, wherein determining that the memory has decreased in importance comprises evaluating at least one of: a time since the memory was last accessed, a time since the memory was created, or a relevancy tag associated with the memory.

6. The method of claim 1, wherein the memory is a shared memory accessible by a plurality of artificial intelligence agents, each agent having independent contextual memory.

7. The method of claim 1, wherein using the compressed memory to respond to a prompt comprises injecting the compressed memory into a context window of a generative artificial intelligence model.

8. The method of claim 1, wherein compressing the memory comprises applying a dynamic compression factor based on at least one of: available storage space, relevancy of the memory, or a predefined compression floor.

9. The method of claim 1, wherein replacing the uncompressed memory with the compressed memory comprises maintaining a reference to an original context of the memory to enable navigation and searching of the memory.

10. A system comprising:
one or more physical processors;
physical memory comprising computer-executable instructions that, when executed by the one or more physical processors, cause the one or more physical processors to:
store, within a storage subsystem of a generative artificial intelligence system, memory of an event, wherein the memory of the event comprises a summary of the event and context associated with the event, and
determine that the memory has decreased in importance for use in responding to prompts provided to a generative artificial intelligence system,
in response to the determination that the memory has decreased in importance, compress the memory such that the compressed memory uses less storage space in the storage subsystem than an uncompressed memory of the event, and
replace the uncompressed memory with the compressed memory in the storage subsystem; and
use the compressed memory to respond to a prompt provided to the generative artificial intelligence system.

11. The system of claim 10, wherein the computer-executable instructions, when executed by at least one of the one or more physical processors, further cause the one or more physical processors to:
store, within a storage subsystem of a generative artificial intelligence system, a memory of an additional event, wherein:
the memory of the additional event comprises context indicating that the memory is a core memory; and
the memory of the event comprises a non-core memory; and
the memory of the additional event has greater importance than the memory of the event and takes up more storage space in the storage subsystem than the memory of the event.

12. The system of claim 10, wherein:
the event comprises a security event; and
the computer-executable instructions cause the one or more physical processors to store the memory of the event by evaluating the event by a plurality of artificial intelligence security operations center agents to identify the context and create the summary.

13. The system of claim 10, wherein the computer-executable instructions cause the one or more physical processors to compress the compressed memory by quantizing a vector that stores the summary of the event.

14. The system of claim 10, wherein the computer-executable instructions cause the one or more physical processors to determine that the memory has decreased in importance by evaluating at least one of: a time since the memory was last accessed, a time since the memory was created, or a relevancy tag associated with the memory.

15. The system of claim 10, wherein the memory is a shared memory accessible by a plurality of artificial intelligence agents, each agent having independent contextual memory.

16. The system of claim 10, wherein the computer-executable instructions cause the one or more physical processors to use the compressed memory to respond to a prompt by injecting the compressed memory into a context window of a generative artificial intelligence model.

17. The system of claim 10, wherein the computer-executable instructions cause the one or more physical processors to compress the memory by applying a dynamic compression factor based on at least one of: available storage space, relevancy of the memory, or a predefined compression floor.

18. The system of claim 10, wherein the computer-executable instructions cause the one or more physical processors to replace the uncompressed memory with the compressed memory by maintaining a reference to an original context of the memory to enable navigation and searching of the memory.

19. A non-transitory computer-readable medium comprising computer-executable instructions that, when executed by one or more physical processors of a computing device, cause the computing device to:
store, within a storage subsystem of a generative artificial intelligence system, memory of an event, wherein the memory of the event comprises a summary of the event and context associated with the event, and
determine that the memory has decreased in importance for use in responding to prompts provided to a generative artificial intelligence system,
in response to the determination that the memory has decreased in importance, compress the memory such that the compressed memory uses less storage space in the storage subsystem than an uncompressed memory of the event, and
replace the uncompressed memory with the compressed memory in the storage subsystem; and
use the compressed memory to respond to a prompt provided to the generative artificial intelligence system.

20. The non-transitory computer-readable medium of claim 19, wherein the computer-executable instructions, when executed by the one or more physical processors, further cause the one or more physical processors to:
store, within a storage subsystem of a generative artificial intelligence system, a memory of an additional event, wherein:
the memory of the additional event comprises context indicating that the memory is a core memory; and
the memory of the event comprises a non-core memory; and
the memory of the additional event has greater importance than the memory of the event and takes up more storage space in the storage subsystem than the memory of the event.
